(19) United States
(12) Patent Application Publication
(10) Pub. No.: US 2024/0352603 A1
(43) Pub. Date: Oct. 24, 2024

(54) 3-DIMENSIONAL STRUCTURED NANOCATALYST CONTAINING NIOBIUM NITRIDE, PREPARATION METHOD THEREOF, AND METHOD FOR ELECTROLYSIS OF FRESHWATER AND SEAWATER BY NIOBIUM-BASED ELECTRODE CELL

(71) Applicant: GWANGJU INSTITUTE OF SCIENCE AND TECHNOLOGY, Gwangju (KR)

(72) Inventors: Junhyeok SEO, Gwangju (KR); Seenivasan SELVARAJ, Gwangju (KR)

(21) Appl. No.: 18/437,197

(22) Filed: Feb. 8, 2024

(30) Foreign Application Priority Data
Apr. 24, 2023 (KR) 10-2023-0053488

(51) Int. Cl. C25B 11/077; C25B 1/04; C25B 11/031; C25B 11/061

(52) U.S. Cl. CPC C25B 11/077; C25B 1/04; C25B 11/031; C25B 11/061

(57) ABSTRACT

The present inventive concept is related to an Nb₄N₅ three-dimensional nanostructure with a nitrogen-doped NbO nanostructure, an Fe₄N/Nb₄N₅ three-dimensional nanocomposite with a nitrogen-doped FeNbO nanostructure, preparation methods thereof, and a method for electrolysis of freshwater and seawater by means of a two-electrode cell composed of an Nb₄N₅ nanostructure electrode and an Fe₄N/Nb₄N₅ nanocomposite electrode. The three-dimensional structured nanocatalyst according to the present inventive concept is economically viable because it has thermodynamic stability under alkaline HER conditions, does not require the use of expensive rare metals in industrial processes, and possesses excellent HER activity, making it a potential substitute for Pt. Moreover, it can provide a low electrical barrier as well as great electrochemical surface area, making it suitable to be designed as an industrial catalyst. Furthermore, according to the present inventive concept, it is possible to demonstrate the water electrolysis method for a long time at high current densities without an increase in cell voltage.

### CROSS-REFERENCE TO RELATED PATENT APPLICATION

This application claims the benefit of Korean Patent Application No. 10-2023-0053488, filed on Apr. 24, 2023, in the Korean Intellectual Property Office, the disclosure of which is incorporated herein in its entirety by reference.

### BACKGROUND OF THE INVENTIVE CONCEPT

### 1. Field of the Inventive Concept

The present inventive concept is related to an electrochemical catalyst for water electrolysis reaction, and more specifically, to a three-dimensional structured nanocatalyst containing niobium nitride, which is suitable for use as an electrode for industrial electrolysis due to its excellent durability and ability to achieve a high current density at a low overpotential, a preparation method thereof, and a method for electrolysis of freshwater and seawater by means of a niobium-based electrode cell.

### 2. Description of the Related Art

Green hydrogen is a globally recognized potential energy vector in multifarious efforts for decarbonizing our atmosphere and restoring climate neutrality. However, in reality, less than 1 percent of global hydrogen production can be labeled green. Producing hydrogen from fossil fuels by steam methane reforming is the cheapest option (0.5-1.7 $/kg), whereas green hydrogen production via alkaline water electrolysis (AWE) is over 4.5 times more costly (2.5-6.0 $/kg), making it commercially challenging to adopt. Therefore, more research efforts should be exerted on enlarging the industrial capacity and decreasing operational costs to utilize green hydrogen. Consequently, long-term research on the development of abundant, kinetically advantageous, and durable catalysts for AWE is being conducted. Recent reports illustrated that pristine catalyst materials commonly underwent irreversible transformations of surface reconstruction/electrochemical reconstruction (hereinafter referred to as “ECR”) according to local electrochemical environments prior to targeted electrochemical reactions, such as the splitting/conversion of small molecules (H₂O, N₂, CO₂, N₂H₄, NH₃, BH₄⁻, etc.) (J. Chen, H. Chen, T. Yu, R. Li, Y. Wang, Z. Shao, S. Song, Recent advances in the understanding of the surface reconstruction of oxygen evolution electrocatalysts and materials development, Electrochem. Energy Rev. 4 (3) (2021) 566-600; and H. Hou, Y. Cong, Q. Zhu, Z. Geng, X. Wang, Z. Shao, X. Wu, K. Huang, S. Feng, Fluorine induced surface reconstruction of perovskite ferrite oxide as cathode catalyst for prolong-life Li-O2 battery, Chem. Eng. J. 448 (2022), 137684).

For transition metal catalysts, ECR is an irreversible dynamic transformation of low-valent metal ions to high-valent active sites, accompanied with unpredictable alteration of physiochemical properties such as morphology, phase, electronic structure, composition, or defect of density. Although the first observation is dated a century ago, the ECR phenomenon was only recently understood thanks to the development of analytical techniques. It has been reported that oxyhydroxide species generated via an ECR process exhibited an improved reactivity than its pristine counterpart, supported by greater electrode-electrolyte interaction (H. Ding, H. Liu, W. Chu, C. Wu, Y. Xie, Structural transformation of heterogeneous materials for electrocatalytic oxygen evolution reaction, Chem. Rev. 121 (21) (2021) 13174-13212; J. Wang, J. Hu, C. Liang, L. Chang, Y. Du, X. Han, J. Sun, P. Xu, Surface reconstruction of phosphorus-doped cobalt molybdate microarrays in electrochemical water splitting, Chem. Eng. J. 446 (2022), 137094; and H. Chu, P. Feng, B. Jin, G. Ye, S. Cui, M. Zheng, G.-X. Zhang, M. Yang, In-situ release of phosphorus combined with rapid surface reconstruction for Co-Ni bimetallic phosphides boosting efficient overall water splitting, Chem. Eng. J. 433 (2022), 133523). However, a few recent reports suggested that not all ECR processes were constructive and could rather deteriorate the electrocatalytic reactivity of pristine catalysts (X. Liu, J. Meng, J. Zhu, M. Huang, B. Wen, R. Guo, L. Mai, Comprehensive understandings into complete reconstruction of precatalysts: synthesis, applications, and characterizations, Adv. Mater. 33 (32) (2021) 2007344, Z.; Wang, J. Li, X. Tian, X. Wang, Y. Yu, K. A. Owusu, L. He, L. Mai, Porous nickel-iron selenide nanosheets as highly efficient electrocatalysts for oxygen evolution reaction, ACS Appl. Mater. Interfaces 8 (30) (2016) 19386-19392).

Indeed, the deterioration of Ni—S and Co—S active sites of pristine NiCO₂S₄/NiMo₂S₄ catalyst during the ECR process was observed, where NiCoOOH real-time active site exhibited poorer oxygen evolution reaction (OER) and hydrogen evolution reaction (HER) activities than the pristine Ni—S and Co—S active sites (S. Seenivasan, D.-H. Kim, Engineering the surface anatomy of an industrially durable NiCo2S4/NiMo2S4/NiO bifunctional electrode for alkaline seawater electrolysis, J. Mater. Chem. A 10 (17) (2022) 9547-9564).

Current understanding of ECR and its impacts on electrocatalysis is not sufficient enough to design industrial scalable electrochemical catalysts. Therefore, research on ECR mechanisms and further modification methods are necessary to design catalysts with predetermined physicochemical and electrochemical properties.

Meanwhile, transition metal nitrides (TMNs) catalysts attracted research interests due to the high electrical conductivity, corrosion resistance, and mechanical stability. The first row (Fe, Co, Ni, Cu) TMNs have been verified for their excellent reactivity in the electrochemical water electrolysis. However, the second and third row (W, Zr, Nb, Mo) TMNs are rarely found in literatures because of difficulties in the synthesis and phase control. Recently, MXene-analogous 2D TMNs were developed as “nitridene” for the electrochemical HER (H. Jin, Q. Gu, B. Chen, C. Tang, Y. Zheng, H. Zhang, M. Jaroniec, S.-Z. Qiao, Molten salt-directed catalytic synthesis of 2d layered transition-metal nitrides for efficient hydrogen evolution, Chem 6 (9) (2020) 2382-2394). Moreover, W-doped Mo-nitride catalysts have been synthesized using alkaline molten salt catalyst, which exhibited the excellent HER. Although many TMNs were reported about the HER activity, their OER activity has been left unexplored because of their instability under oxidative potentials.

### SUMMARY OF THE INVENTIVE CONCEPT

The present inventive concept has been made in an effort to solve the above-described problems associated with prior art, and an object of the present inventive concept is to provide a three-dimensional catalyst containing niobium nitride for water electrolysis reaction, which can achieve a high current density at a low overpotential. Another object of the present inventive concept is to provide a method for preparing a three-dimensional catalyst containing niobium nitride for water electrolysis reaction by a constructive ECR process.

Still another object of the present inventive concept is to provide a method for electrolysis of freshwater and seawater by means of a niobium-based electrode cell that is suitable for industrial electrolysis due to its excellent durability.

One aspect of the present inventive concept for achieving the above-described object is to provide an Nb₄N₅ three-dimensional catalyst for a water electrolysis with a nitrogen-doped NbO nanostructure.

One aspect of the present inventive concept for achieving the above-described object is also to provide an Fe₄N/Nb₄N₅ three-dimensional catalyst with a nitrogen-doped FeNbO nanostructure.

Another aspect of the present inventive concept for achieving the above-described object is to provide a method for preparing three-dimensional catalyst, comprising forming precursor solution by dissolving niobium chloride, oxalic acid and in solvent; adding hexamethylenetetramine to the precursor solution, so that oxide containing Nb is formed by hydrothermal reaction; and supplying ammonia gas to the oxide to perform nitrogen doping under thermal nitrification condition.

Still another aspect of the present inventive concept for achieving the above-described object is to provide a method for electrolysis of freshwater and seawater by means of a two-electrode cell composed of an Nb₄N₅ nanostructure electrode and an Fe₄N/Nb₄N₅ nanocomposite electrode.

The three-dimensional catalyst containing niobium nitride according to the present inventive concept is economically viable because it has thermodynamic stability under alkaline HER conditions, does not require the use of expensive rare metals in industrial processes, and possesses excellent HER activity, making it a potential substitute for Pt. Moreover, it can provide a low electrical barrier as well as great electrochemical surface area, making it suitable to be designed as an industrial catalyst. Furthermore, the three-dimensional catalyst containing niobium nitride according to the present inventive concept exhibits excellent performance and durability in both HER and OER half-cells, demonstrating electrolysis of freshwater and seawater for a long time at high current densities without an increase in cell voltage.

### BRIEF DESCRIPTION OF THE DRAWINGS

The above and other features and advantages of the present inventive concept will become more apparent by describing in detail exemplary embodiments thereof with reference to the attached drawings in which:

FIG. 1 illustrates a) XRD spectra of NbN and FeNbN grown on Ni foam according to one embodiment of the present inventive concept, high-resolution XPS of NbN and FeNbN samples in the b) Nb 3d and c) N 1s regions, d), e) HR-SEM images of FeNbN sample, HR-TEM images of f) NbN and g), h) FeNbN samples, and i), j) high magnification HR-TEM images of FeNbN sample with diffraction plane analysis;

FIG. 2 illustrates a) XRD spectra of FeNbN electrode, and b) high-resolution Fe 2p spectra of FeNbN electrode;

FIG. 3 shows HR-SEM images of NbN catalyst;

FIG. 4 shows STEM-EDS images of FeNbN catalyst;

FIG. 5 shows HR-SEM images of FeN catalyst;

FIG. 6 shows a) CV curves of FeN, NbN and FeNbN electrode samples and Pt/C in HER half-cell, b) comparison of mass activity, c) UPS spectra in cutoff region, d) plot of exchange current density and calculated work function, e) compared HER activity of transition metal catalysts from recent reports, f) Tafel plot, g) turn-over frequency, and h) Nyquist plot at −0.25 VRHE;

FIG. 7 shows CV curves of a) NbN, b) FeN, and c) FeNbN electrodes in HER half-cell with and without iR-correction;

FIG. 8 shows the reduction peak from CV curves in 1M KOH electrolyte at a scan rate of 50 mV/s;

FIG. 9 shows the electronic equivalent circuit used for data fitting from FIGS. 6h and 10g;

FIG. 10 shows a) CV curves of the prepared catalysts and RuO₂ in OER half-cell, b) Tafel plot, c) comparison of OER activity with recent results using non-oxide transition metal catalysts, d) mass activity, e) turnover frequency, f) calculations of C_{dl}, and g) Nyquist plot at 1.60 V_{RHE};

FIG. 11 shows XRD spectra of NbN electrode used as the cathode for continuous electrolysis for 10 days (100 mA/cm², 60° C.);

FIG. 12 shows a) high-resolution XPS spectra of Nb 3d and b) N 1s for the NbN electrode used as the cathode for continuous electrolysis for 10 days (100 mA/cm², 60° C.);

FIG. 13 shows CV curves of each catalyst after ECR: a) NbN, b) FeNbN, c) FeN, and d) is the magnified region of (c);

FIG. 14 shows CV curves of a) NbN, b) FeN, and c) FeNbN electrodes in OER half-cells with or without iR-correction;

FIG. 15 shows cyclic voltammetry curves of a) NbN, b) FeNbN, and c) FeN with electrochemical active surface area (ECSA) estimated by electrochemical double-layer capacitance (Cdl) (at different scan rates in 1M KOH solution);

FIG. 16 shows a) OER current density measured at 1.5 VRHE, b) magnified CV curves of NbN and FeNbN catalysts (with 5-cycle interval) derived from FIG. 13, d) XRD spectra of all catalysts after ECR, e) high-resolution Nb 3d spectra of NbN and FeNbN catalysts after ECR, and f) high-resolution Fe 2p spectra of the FeNbN catalyst after ECR, and g) ratio of Fe chemical states before and after ECR;

FIG. 17 is a schematic diagram illustrating the transition from destructive reconstruction to constructive reconstruction through active site optimization in the catalysts according to the present inventive concept;

FIG. 18 shows high-resolution N 1s spectra of NbN, FeNbN, and FeN catalysts after ECR;

FIG. 19 shows a) OER current density measured at 1.5 VRHE for FeO catalyst (with 5-cycle interval) and b) ratio of Fe3+/Fe2+ states before and after ECR;

FIG. 20 shows a) and b) HRTEM images of FeNbN sample after ECR, c) ECSA-normalized current density of NbN, FeN, and FeNbN samples, and d) to i) STEM-EDS analysis of FeNbN samples after ECR;

FIG. 21 shows HR-TEM images of NbN catalyst after ECR;

FIG. 22 shows a) rs-Isv curves of an NbN∥FeNbN water-splitting full-cell under different operating conditions, b) overpotentials (cell voltage −1.23) required to deliver different current densities, c) chronopotentiometry curves of an NbN|FeNbN cell at 100 mA/cm² for 10 days, d) amounts of O₂ and H₂ gases measured at a current density of 100 mA/cm² in seawater electrolyte at 25° C., g) corresponding Faraday efficiency, e) and f) HR-SEM images of NbN, h) and i) HR-SEM images of FeNbN electrode after 10 days of operation, j) high-resolution XPS spectra in Ca 2p, k) Mg 1s, and I) Cl 2p regions after 10 days of operation;

FIG. 23 shows RS-LSV curves of the NbN∥FeNbN water-splitting full-cell under different operating conditions: a) 25 wt % KOH and 60° C., b) 25 wt % KOH and 25° C., and c) 3.33 wt % KOH and 25° C.; and

FIG. 24 shows RS-LSV curves of the NbN|FeNbN full-cell before and after 10 days of electrolysis.

### DETAILED DESCRIPTION OF THE INVENTIVE CONCEPT

Hereinafter, the present inventive concept will be described with reference to the attached drawings. In the drawings, to clearly and briefly explain the present disclosure, an illustration of elements having no connection with the description is omitted, and similar elements are denoted by the same reference numerals throughout the specification. Moreover, the disclosed examples are merely illustrative of the present inventive concept specifically and do not limit the scope of the claims of the present inventive concept.

### EXAMPLES 1 and 2

### Synthesis of Nb₄N₅(NbN) and Fe₄N/Nb₄N₅ (FeNbN) Catalysts

1) Synthesis of NbO·H₂O (NbO) and FeNbO·H₂O (FeNbO)

NbO catalysts were synthesized on Ni foam by a hydrothermal method. A piece of Ni foam (NF) was ultrasonically cleaned for several minutes in ethanol and deionized (DI) water and dried. The cleaned NF (2 cm×5 cm) was transferred to a Teflon-lined autoclave containing a precursor solution. The precursor solution was prepared by dissolving 0.381 g of niobium chloride and 0.875 g of oxalic acid in 70 ml of deionized water and stirred for 1 hour to obtain a clear solution. 0.49 g of hexamethylenetetramine was then added and a hydrothermal reaction was conducted at 180° C. for 12 hours. Finally, the obtained NbO on Ni foam was rinsed with deionized water and ethanol and then dried at 60° C. for further use, so that NbO·H₂O (NbO) was prepared. FeNbO·H₂O (FeNbO) was prepared via the same method with an additional 0.16 g of iron nitrate added to the precursor solution.

### 2) Synthesis of FeO·H₂O (FeO)

The precursor solution containing 0.678 g of iron nitrate, 0.35 g of urea, and 0.107 g of ammonium fluoride in 70 ml of deionized water was used in the preparation of FeO on Ni foam substrates. The hydrothermal reaction was conducted at 120° C. for 10 hours. Finally, the obtained FeO on Ni foam was rinsed with deionized water and ethanol and then dried at 60° C. for further use.

### 3) Thermal Nitrification

Thermal nitrification of as-prepared oxide samples was carried out in a tube furnace at 550° C. for 60 min under a mixture of ammonia (200 sccm) and argon (50 sccm) gases flowing at a heating rate of 5° C./min, then cooled down naturally to room temperature under argon gas flow (250 sccm). The resulting NbO, FeNbO and FeO samples were subjected to nitrogen doping under thermal nitrification conditions to obtain Nb₄N₅ (NbN) according to Example 1, Fe₄N/Nb₄N₅ (FeNbN) and Fe₄N (FeN) catalysts according to Example 2, respectively.

### Characterization of Prepared Catalysts

The crystallinity of the prepared catalysts was analyzed using a high-resolution X-ray diffractometer (XRD; Rigaku) with a PIXcel^{2D} detector and equipped with Cu Kα radiation source at 9 KW. High-resolution X-ray photoelectron spectroscopy (XPS; NEXSA, Thermo Fisher Scientific) with Al Kα radiation and a 128-channel detector was used. The structural and morphological properties of the electrodes were characterized by high-resolution scanning electron microscopy (HR-SEM; Verios 5UC, Thermo Fisher Scientific) coupled with an energy-dispersive X-ray spectroscopy (EDS) analyzer (accelerating voltage 30 kV), as well as high-resolution transmission electron microscopy (HR-TEM, Tecnai G2 F20 S-Twin).

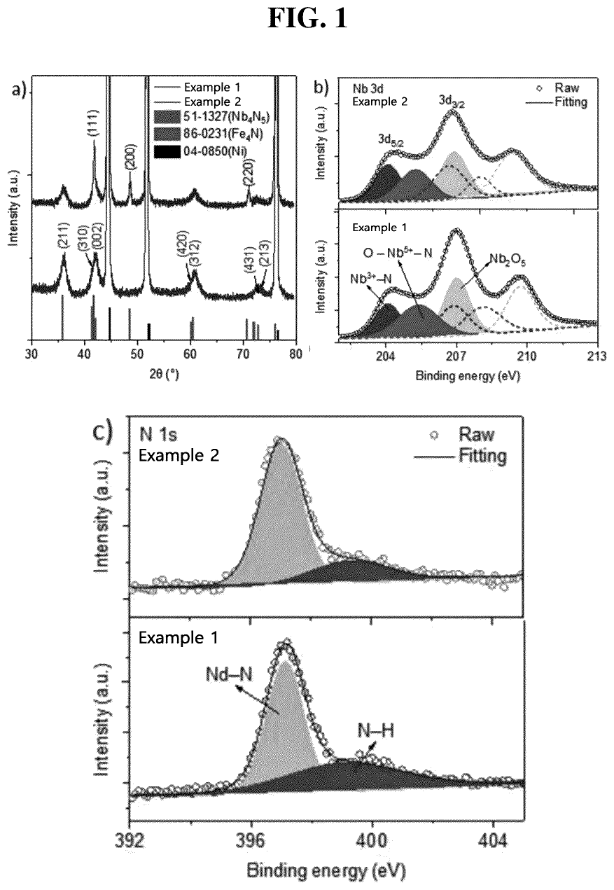

XRD spectra of all pristine catalysts are compared as shown in FIG. 1a. The NbN catalyst showed crystalline peaks of the Nb₄N₅ phase at 36.0°, 41.74°, 42.33°, and 60.81°, corresponding to (211), (310), (002), and (312) diffraction planes, respectively. Diffraction peaks of Ni foam are observed together in the overall XRD spectra (JCPDS: 04-0850). Upon incorporation of Fe ions, the XRD spectra show additional peaks of the Fe₄N phase at 41.79°, 48.53°, and 70.92°, corresponding to (111), (200), and (220) diffraction planes, respectively. This indicates that Fe₄N exists as a separate phase, rather than being incorporated into the Nb₄N₅ crystal through Fe doping. The FeN control sample also exhibits peaks similar to the Fe₄N phase as shown in FIG. 1a. Therefore, the FeNbN electrode is identified as a composite form with a heterojunction between two phases of Nb₄N₅ and Fe₄N. The high-resolution XPS spectra of NbN and FeNbN samples in the Nb 3d region show combination of 3+ and 5+ oxidation states as shown in FIG. 1b. Intrinsic state of Nb³⁺ corresponds to Nb—bond, with assignment of the 3d_{5/2} and 3d_{3/2} orbital binding energies at 204.1 eV and 206.9 eV, respectively.

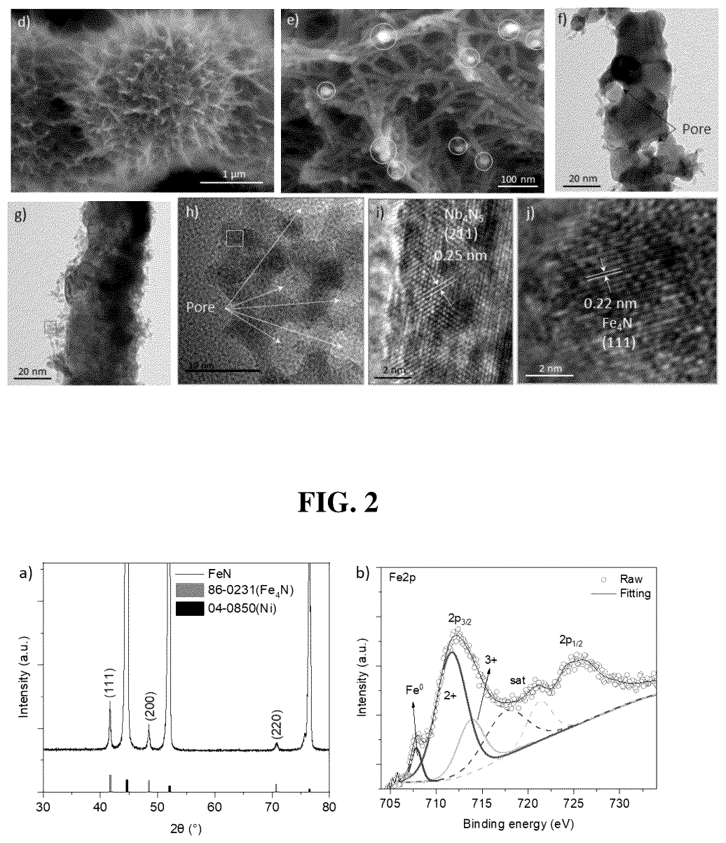

Partially oxidized Nb⁵⁺ species (O—Nb—N) appear at 205.4 eV and 208.2 eV. Binding energy peaks at 207.0 eV and 209.7 eV correspond to a completely oxidized Nb⁵⁺ species (Nb₂O₅). The Fe 2p region scan of FeNbN sample shows a metallic Fe peak at 707.8 eV along with Fe²⁺ and Fe³⁺ states at 711.69 eV and 714.8 eV, respectively, as shown in FIG. 2. Metallic Fe is derived from a high-temperature reduction step during the thermal nitrification, whereas Fe³⁺ state was derived from surface oxidation step under air exposure. The N 1s region scan of NbN and FeNbN samples show two distinguishable peaks at 397.0 eV and 399.4 eV corresponding to Nb—N and N—H bonds, respectively, as shown in FIG. 1c.

FIGS. 1d and 1e show HR-SEM images of FeNbN sample, and FIG. 3 shows HR-SEM images of NbN sample, these HR-SEM images being obtained to visualize the surface morphology. The NbN and FeNbN catalysts presented a unique morphology similar to a vast network with long human brain cell-like structures and interconnected clusters through a linkage. The human brain cell-like structure had an average thickness of about 20 nm.

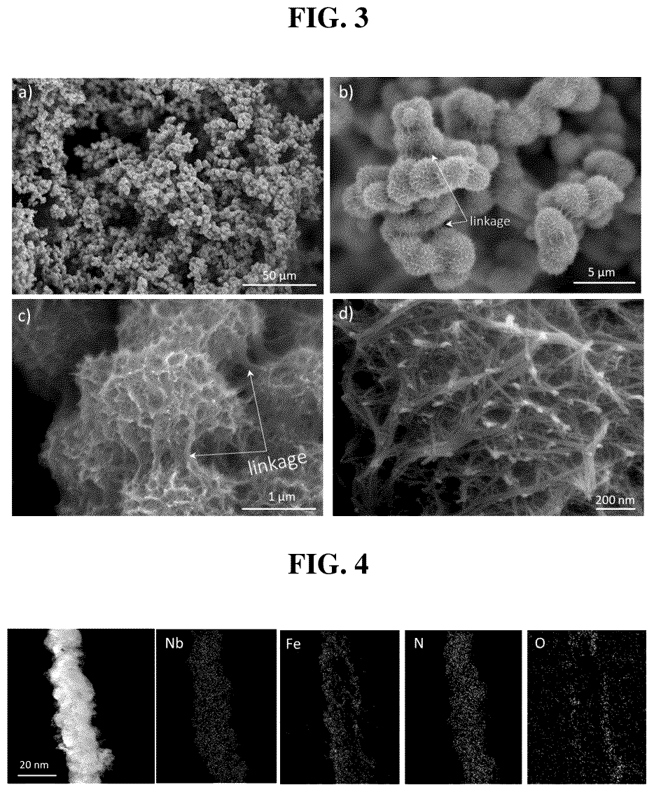

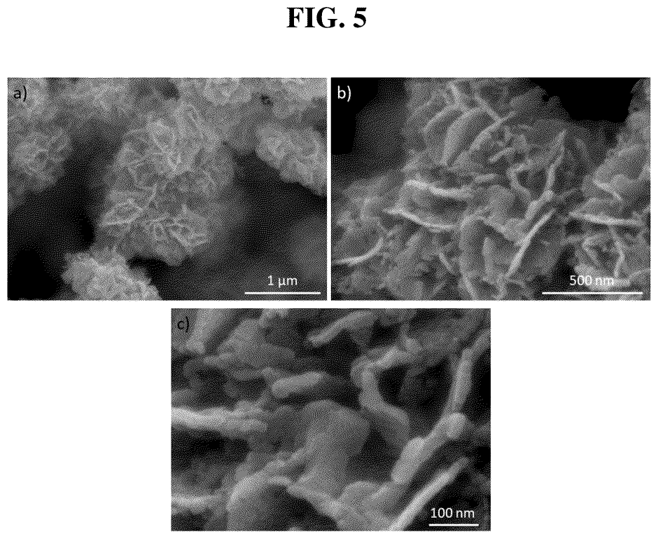

As shown in FIG. 1e, in the FeNbN catalyst according to the present inventive concept, they were connected with each other at multiple centers seen as bright white dots, which could drastically lower the electrical barrier for electron transfer. As shown in FIG. 1f, the HR-TEM image of NbN sample displayed smooth surface composed of Nb₄N₅ crystals with various size parameters and particle agglomeration with pores. This morphology could provide a low electrical barrier as well as great electrochemical surface area. As shown in FIG. 1g, the HR-TEM image of FeNbN sample displayed random formation of Fe₄N nanoparticles on Nb₄N₅ surface. The Fe₄N nanoparticles also had a well-defined porous structure with a high crystallinity as shown in FIG. 1h (of blue square in FIG. 1g). The high magnification HR-TEM image in FIG. 1i (of red square in FIG. 1g) showed the d-spacing value of 0.25 nm corresponding to the (211) plane of Nb₄N₅, and FIG. 1j (of square in FIG. 1h) displayed the d-spacing value of 0.22 nm corresponding to the (111) plane of Fe₄N. As shown in FIG. 4, the STEM-EDS mapping images of FeNbN sample exhibited random distribution of Fe elements overall the Nb₄N₅ surface. Physicochemical analysis of pristine catalysts determined that the incorporation of Fe ions barely affected the Nb₄N₅ crystal structure but separately formed the Fe₄N phase, randomly distributed over the Nb₄N₅ surface. HR-SEM images of FeN sample are shown in FIG. 5. The FeN catalyst had an interconnected plate-like structure with a thickness range of 20 nm to 30 nm.

### Comparative Example 1

### Preparation of Pt/C Electrode

10 mg of Pt/C and 10 μL of Nafion were dispersed in 1 ml of a water/ethanol mixture solution (3:1) using ultra-sonication to prepare a catalyst ink. Then, the catalyst ink was coated on the NF by drop casting followed by drying at 60° C.

### Comparative Example 2

### Preparation of RuO₂ Electrode

10 mg of RuO₂ and 10 μL of Nafion were dispersed in 1 ml of a water/ethanol mixture solution (3:1) using ultra-sonication to prepare a catalyst ink. Then, the catalyst ink was coated on the NF by drop casting followed by drying at 60° C.

### Experimental Example 1

### Electrochemical Measurement

Electrochemical measurements were conducted using a three-electrode system, wherein Hg/HgO electrode and graphite rod were used as a reference and a counter electrode, respectively. The catalytic performance of electrode samples was tested using cyclic voltammetry (CV) in 1 M KOH electrolyte at a scan rate of 2 mV/s to minimize the capacitive current. The measured potentials versus Hg/HgO were converted to a reversible hydrogen electrode (RHE) using the Nernst equation. Electrochemical impedance spectroscopy measurements were conducted in 1 M KOH at frequencies ranging from 10.2 Hz to 105 Hz. Electrochemically active surface area (ECSA) was estimated by calculating electrochemical double-layer capacitance (C_{dl}) in a non-Faradaic potential region. CV was performed at scan rates of 5 mV/s, 10 mV/s, 20 mV/s, 30 mV/s, 40 mV/s, and 50 mV/s. Plotting the current density difference (Δl) against scan rate gives a slope of 2C_{dl}, where 2C_{dl}=d(Δl)/dv. The number of surface active sites (N_{A}) was calculated using the integrated area of reduction peak obtained from the CV curve of each catalyst.

### Experimental Example 2

### Seawater Electrolysis

For the evaluation of the overall seawater electrolysis, electrolyte was prepared using seawater (collected at Haeundae Beach, Busan, South Korea). Catalytic activities were measured in a two-electrode H-cell configuration separated by a Sustainion X37-50 anion exchange membrane. Electrolysis was performed both in a laboratory mode (3.33 wt % of KOH, 25° C.) and industrial mode (25 wt % of KOH, 60° C.). Chronopotentiometry measurements (25 wt % KOH, 60° C., 100 mA/cm²) were performed in the same two-electrode H-cell configuration with frequent replacements of electrolyte. The amount of gas generated during the electrolysis was analyzed by gas chromatography (WE-Glassy carbon-05-00-PTFE-08.5-80, Wizmac).

### Experimental Example 3

### Electrocatalysis

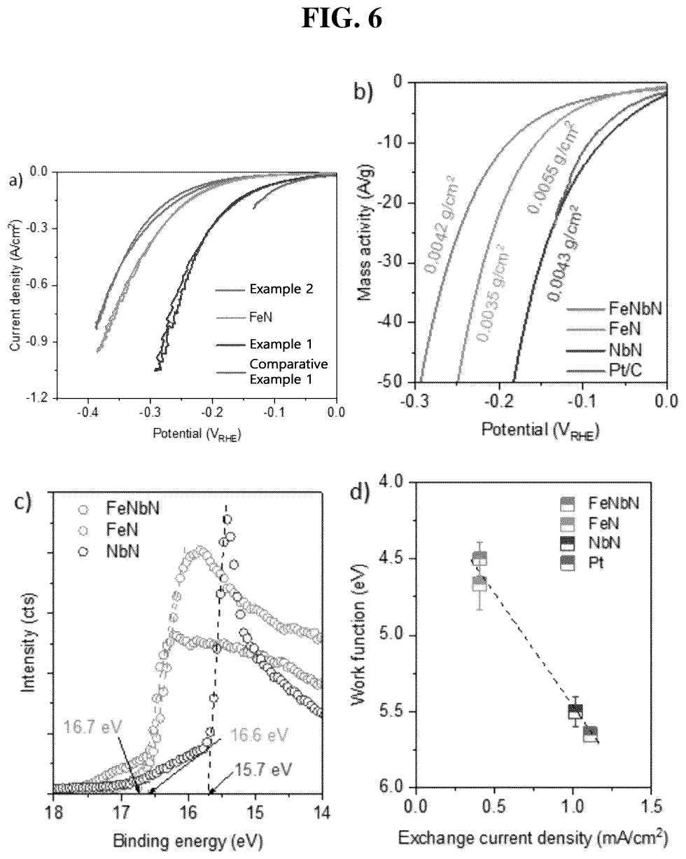

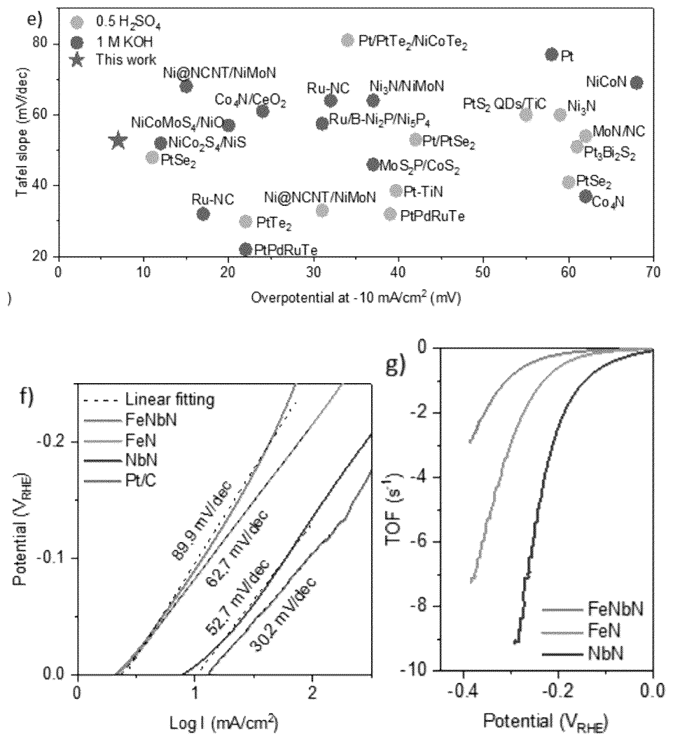

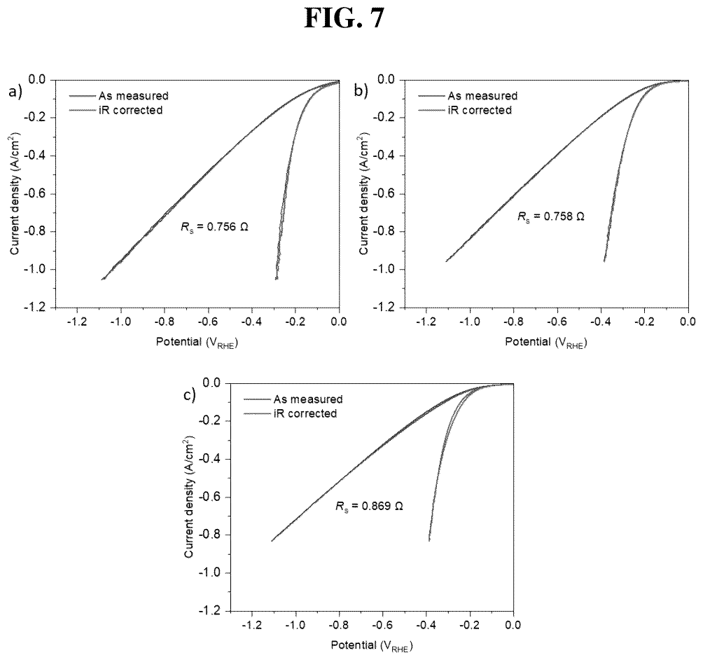

FIG. 6a shows comparative CV curves of NbN, FeN, and FeNbN samples obtained in HER half-cell, which were iR-corrected using the series resistance value (Rs) measured by impedance spectroscopy. The NbN catalyst achieved a current density of 10 mA/cm² that only required 7 mV overpotential (recorded the same both with and without iR-correction), presenting a new benchmark for non-precious metal-based electrocatalysts. The FeN and FeNbN catalysts exhibited relatively large overpotentials of 68 mV and 78 mV at 10 mA/cm², respectively (with iR-correction). Thanks to the excellent electrical conductivity, the NbN catalyst achieved a high current density of 1 A/cm² with an overpotential of only 281 mV. The LSV curves before iR-correction are shown in FIG. 7 for comparison. The mass activity of NbN, FeN, and FeNbN electrodes according to Comparative Example 1 and commercial Pt/C were compared as shown in FIG. 6b, where the NbN catalyst outperformed the commercial Pt/C. In the case of transition metal catalysts, the metal-hydride (M—H) bond cleavage is commonly the rate-determining step in the HER catalysis. To evaluate the M—H bond strength, the work function of each catalyst was obtained through ultraviolet photoelectron spectroscopy (UPS). As shown in FIG. 6c, the values of cutoff energy (E_{cutoff}) were derived by normalizing the secondary electron cutoff spectra. The work function (W) was calculated according to the following equation:

$$W = hv - \vert {E}_{cutoff} - {E}_{f} \vert$$

where hv is energy of a photon and E_{f} is Fermi edge. The calculated W value of each NbN, FeNbN, and FeN catalyst is 5.50 eV, 4.50 eV, and 4.66 eV, respectively. As shown in FIG. 6d, the plot between exchange current density (i₀) and W shows a linear relationship. The excellent proton reduction ability, which is almost equivalent to Pt/C electrode, is due to intrinsic work function of the NbN catalyst close to Pt (5.65 eV).

As shown in FIG. 6f, the catalyst obtains a Tafel slope value of 52.7 mV/dec, indicating that the HER follows the Volmer-Heyrovsky mechanism. The FeN (62.7 mV/dec) and FeNbN (89.9 mV/dec) catalysts show slightly larger Tafel slopes, attributed to the lower N_{A} values than that of the NbN catalyst. The commercial Pt/C according to Comparative Example 1 exhibits a lower Tafel value than NbN sample, corresponding to its Volmer-Tafel mechanism. Contradiction between the mass activity and the HER kinetics of Pt/C and NbN samples is because of the electrical barrier between Pt/C and Ni foam substrate.

According to the Examples and Comparative Examples, the NbN catalyst comes to have strong electrical contact with Ni foam substrate by growing directly on the Ni foam substrate, whereas the Pt/C catalyst is prepared by physical deposition. Overpotentials at −10 mA/cm² and Tafel slope values of the precious metal and non-oxide transition metal catalysts are compared in FIG. 6e and Table 1 below.

TABLE 1

| | | OER | Tafel | HER | Tafel | |
|---|---|---|---|---|---|---|
| S. | | overpotential | slope | overpotential | slope | Stability |
| No. | Catalyst | (mV) | (mV/dec) | (mV) | (mV/dec) | (h) |
| | Fe₄N/Nb₄N₅ | 224 | 30.3 | — | — | 240 h at |
| | Nb₄N₅ | — | — | 7 | 52.7 | 100 mA/cm² |
| 1 | NiCoMoS₄/NiO | 186 | 42 | 20 | 57 | 720 h at |
| | | | | | | 100 mA/cm² |
| 2 | CoVFeN | 212 | 34.8 | — | — | 100 |
| 3 | BiFeOₓH_{y} | 232 | 34 | — | — | 1000 h at |
| | | | | | | 1000 mA/cm² |
| 4 | Ru/B—Ni₂P/Ni₅P₄ | 270 | 46.7 | 31 | 57.5 | 10 |
| 5 | 1T/2H—MoS₂/CoS₂ | 261 | 85 | 37 | 46 | 100 h at |
| | | | | | | 20 mA/cm² |
| 6 | NiMoN | 230 | 116 | 22 | 101 | 36 |
| 7 | NiMoN/Ni₃N | 277 | 118 | 37 | 64 | 20 |
| 8 | Ni₃FeN/r-GO | 270 | 54 | 94 | 90 | 100 |
| 9 | Fe—NiMoN | 228 | 41 | 115 | 109 | 24 |
| 10 | P—Fe₃N | 270 | 89.72 | 102 | 68.59 | 60 |
| 11 | NiCoN | 247 | 63 | 68 | 69 | 24 |
| 12 | Co₄N—CeO₂/Graphite | 239 | 37.1 | 24 | 61 | 50 |
| 13 | W₂N/WC | 320 | 83.8 | 148.5 | 47.4 | 10 |
| 14 | Ru—NC | — | | 17 | 32 | — |
| 15 | *Pt—TiN | — | | 139 | 98.3 | 60 |
| 16 | NiCo₂S₄/NiS | 34 | 79 | 12 | 52 | 240 h at |
| | | | | | | 100 mA/cm² |
| 17 | Ru—NC | — | — | 32 | 64 | — |
| 18 | Pt | — | — | 58 | 77 | — |
| 19 | PtPdRuTe | — | — | 22 | 22 | — |
| 20 | *PtSe₂ | — | — | 11 | 48 | — |
| 21 | *PtTe₂ | — | — | 22 | 29.9 | — |
| 22 | *Pt/PtTe₂/NiCoTe₂ | — | — | 34 | 81 | — |
| 23 | *PtPdRuTe | — | — | 39 | 32 | — |
| 24 | *PtSe₂/Pt | — | — | 42 | 53 | — |
| 25 | *PtS₂ QDs | — | — | 55 | 60 | — |
| 26 | *PtSe₂ | — | — | 60 | 41 | — |
| 27 | *Pt₂Bi₂S₂ | — | — | 61 | 51 | — |
| 28 | *Ni₃N | — | — | 59 | 60 | 12 |
| 29 | *MoN/NC | — | — | 62 | 54 | 15 |
| 30 | *Ni@NCNT/NiMoN | — | — | 31 | 33 | — |
| 31 | Fe—Co₃N | 294 | 49 | — | — | — |
| 32 | H—Ni₂Fe₂N/ | 251 | 35 | — | — | — |
| | Ni₃Fe@N—CS NPs | | | | | |
| 33 | Ni—MoN | — | — | 24 | 35.5 | 200 |

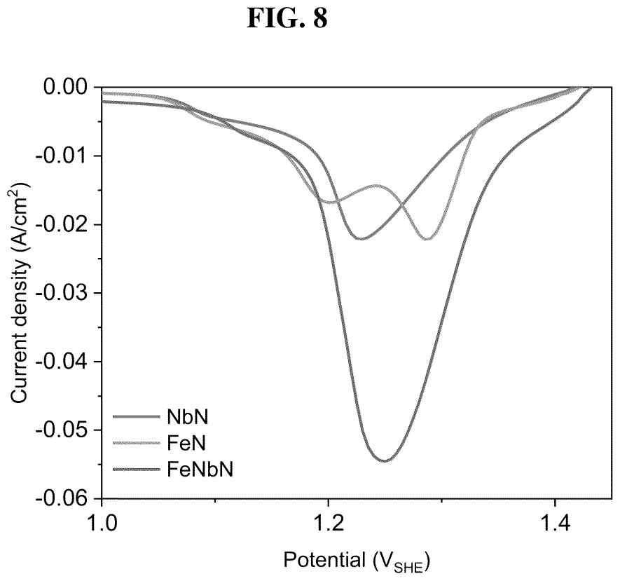

Turnover frequency (TOF) of each catalyst is calculated using NA value measured from the reduction peak shown in FIG. 8, assuming single electron transfer between electrode-electrolyte interface. As shown in FIG. 6g, the TOF value trend is consistent with the I-V curves obtained using the NbN, FeN, and FeNbN electrodes. The results indicates that Nb—N active sites are kinetically more favorable for HER than Fe—N active sites in the FeNbN and FeN electrodes. Nitrogen has a higher electronegativity and lower water adsorption energy than niobium. Therefore, the N site in Nb—N bond easily traps alkaline water under the HER potential. The higher electron density compared to other catalyst materials enables NbN to easily dissociate alkaline water by attracting electrophilic H⁺ and simultaneously repelling nucleophilic OH.

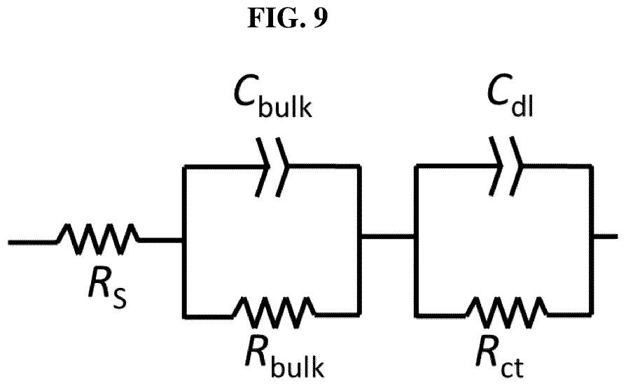

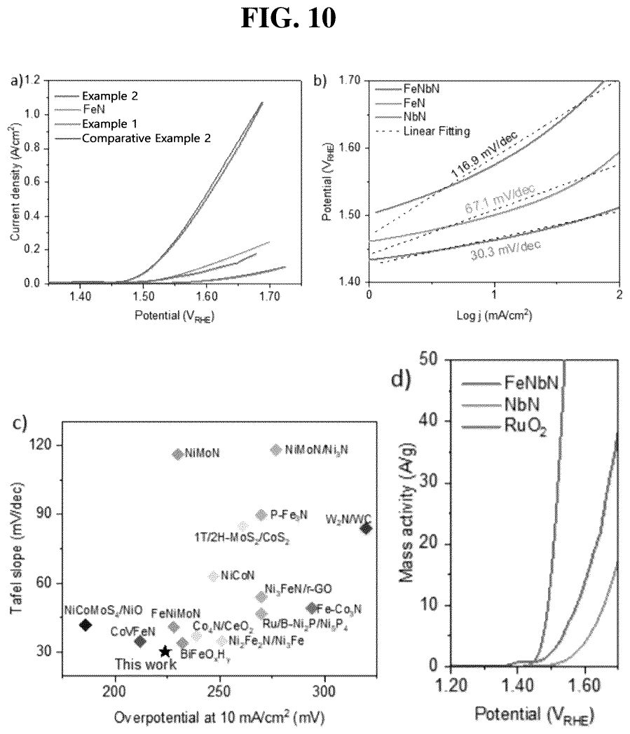

The Nyquist plots for the NbN, FeNbN and FeN electrodes are shown in FIG. 6h. FIG. 9 shows the equivalent circuit used for impedance data fitting from FIGS. 6h and 10g. The fitted results are listed in Table 2 below.

TABLE 2

| | | R_{S} | C_{bulk} | R_{bulk} | C_{dl} | R_{ct} |
|---|---|---|---|---|---|---|
| | Catalyst | (Ω) | (mF/cm²) | (Ω) | (mF/cm²) | (Ω) |
| HER | NbN | 0.741 | 1.874 | 0.082 | 1.008 | 0.892 |
| (−0.25 V_{RHE}) | FeNbN | 0.889 | 0.350 | 0.136 | 0.059 | 2.165 |
| | FeN | 0.856 | 0.013 | 1.143 | 0.082 | 1.509 |
| OER | NbN | 1.071 | 0.043 | 0.646 | 0.351 | 1.369 |
| 1.6 V_{RHE}) | FeNbN | 1.086 | 0.042 | 0.027 | 0.125 | 0.206 |
| | FeN | 1.058 | 0.056 | 0.028 | 0.060 | 0.232 |

The measured charge transfer resistance (R_{ct}) value of each NbN, FeNbN, and FeN catalyst is 0.892, 2.165, and 1.509 Ω, respectively. The lowest R_{ct} value of the NbN electrode indicates the fastest HER kinetics at the electrode-electrolyte interface. Furthermore, the NbN electrode has the lowest bulk resistance (R_{bulk}), which denotes the high electrical conductivity. According to the Pourbaix diagram, the M—H bonds are stable under alkaline HER operating conditions.

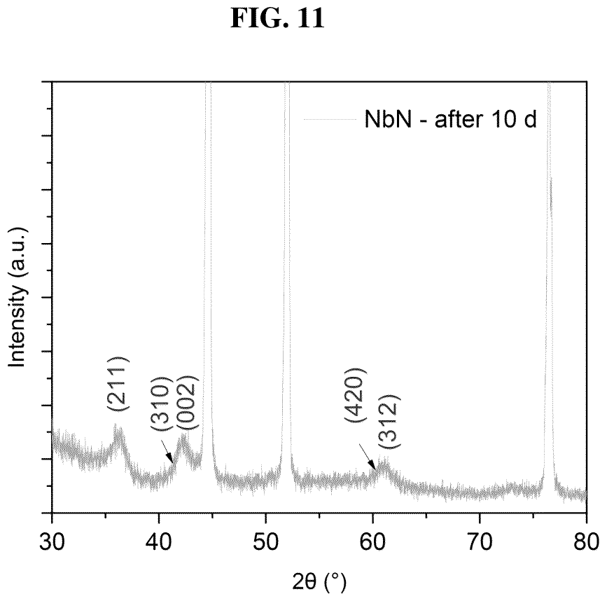

As shown in FIG. 11, the XRD spectrum of the NbN catalyst after a long-term electrolysis shows conversion of the characteristic peaks of Nb₄N₅, which indicates that the NbN catalyst is highly stable and resistant to ECR under alkaline HER conditions.

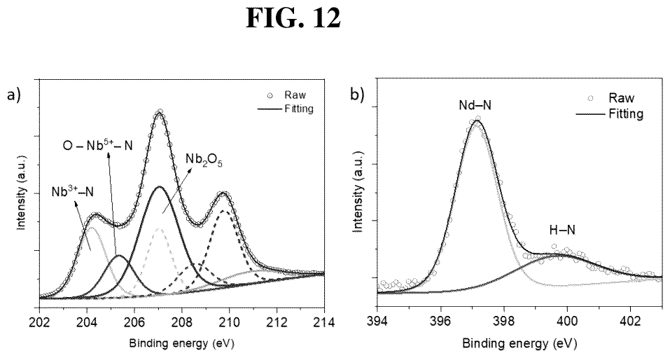

Additionally, in FIG. 12, the high-resolution XPS spectra in the Nb 3d region also show binding energy peaks corresponding to Nb—N and O—Nb—N bonds after long-term HER. The N 1s area scan does not exhibit significant changes after long-term electrolysis. The results confirm that the NbN catalyst according to the present inventive concept is thermodynamically stable under alkaline HER conditions and has superior HER activity, capable of replacing platinum in industrial processes.

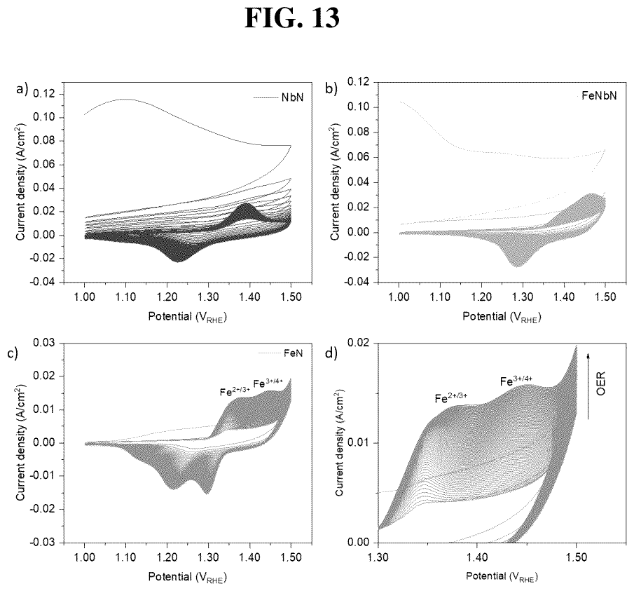

Prior to analyzing the OER activity of the catalysts, a sustainable electrode-electrolyte interface is prepared for each catalyst through an ECR process by performing 200 CV cycles from 1.0 to 1.5 VRHE at 50 mV/s scan rate. As shown in FIG. 13, the stable shapes of the CV curve indicate the completion of the ECR process. After ECR was completed, CV curves between 1.0 to 1.8 V_{RHE} at 2 mV/s scan rate are obtained and cathodic sweep is used to determine the OER overpotential for each catalyst.

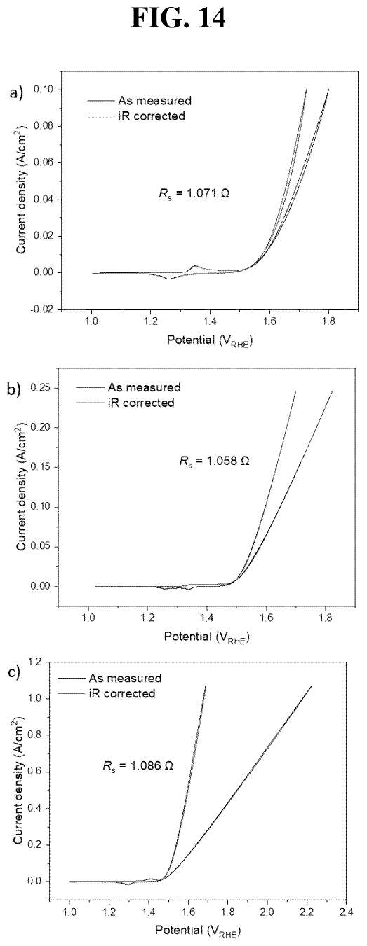

The CV curves (iR-corrected) obtained in the potential range of OER are shown in FIG. 10a. In contrast to the HER half-cell, the FeNbN catalyst exhibits superior performance compared to other catalysts. The FeNbN sample achieves a current density of 10 mA/cm² at an overpotential of 224 mV, whereas the NbN and FeN samples require larger overpotentials of 340 and 264 mV, respectively. Furthermore, the FeNbN catalyst only requires an overpotential of 438 mV and can achieve a high current density of 1 A/cm². CV curves without iR-correction are shown in FIG. 14 for comparison.

Tafel slope of FeNbN catalyst records a low value of 30.3 mV/dec as shown in FIG. 10b, whereas FeN (67.1 mV/dec) and NbN (116.9 mV/dec) catalysts has relatively large values. The drastic change between NbN and FeNbN indicates that those two catalysts possess different active sites for OER (Nb site for NbN vs Fe site for FeNbN). The low Tafel slope of the FeNbN electrode is attributed to the fast charge transfer kinetics at the electrode/electrolyte interface. The OER performance of FeNbN sample is compared with recent reports in FIG. 10c and Table 1.

As shown in FIG. 10d, the mass activity of FeNbN (0.0042 g/cm²) and NbN (0.0043 g/cm²) catalysts are compared with RuO₂ (0.0055 g/cm²) according to Comparative Example 2 as loaded on Ni foam substrate. The FeNbN electrode exhibits greater activity than the RuO₂ in the OER half-cell reaction. As shown in FIG. 10e, the calculated TOF values present that FeNbN electrode can catalyze water oxidation even faster than NbN and FeN electrodes. Although both FeNbN and FeN electrodes have Fe active sites, Fe active sites nearby Nb site exhibits faster kinetics as realized from the Tafel plots and TOF analyses.

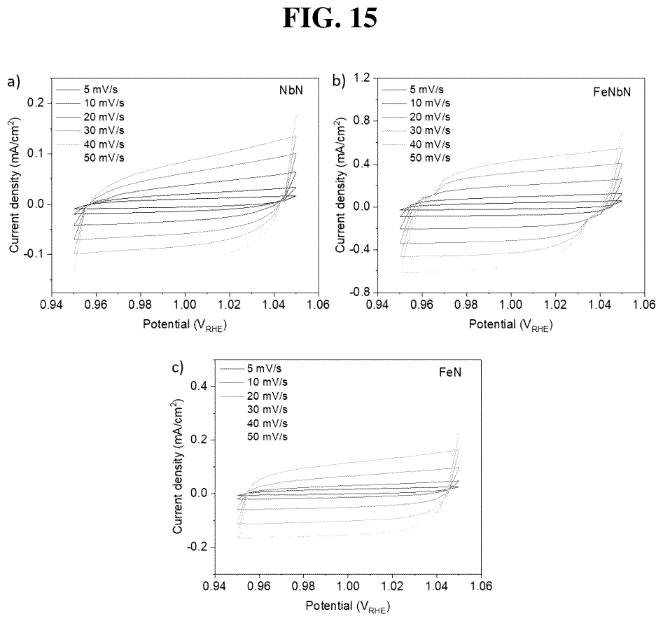

Double layer capacitance is calculated from the non-Faraday CV curve as shown in FIG. 15. According to FIG. 10f and Table 3 below, the FeNbN sample has a higher electrochemical surface area (ECSA) of 289.75 cm² than NbN (57.75 cm²) and FeN (116.25 cm²) samples.

TABLE 3

| Electrode | C_{dl} (mF/cm²) | ECSA (cm²) |
|---|---|---|
| NbN | 2.31 | 577.50 |
| FeNbN | 11.59 | 289.75 |
| FeN | 4.65 | 116.25 |

Apparently, the incorporation of Fe ion into NbN redirects the ECR phenomenon to increase the surface porosity compared to pristine NbN. Further details on active sites and ECR process will be described below. The Nyquist plot obtained at 1.6 V_{RHE} shows that FeNbN has the lowest R_{ct}, which indicates that the surface has the smallest energy barrier for charge transfer. The larger R_{ct} value for NbN is associated with catalytically inactive Nb sites over the surface. The equivalent circuit used for fitting and the results are shown in FIG. 9 and Table 2.

### Experimental Example 4

### Active Sites Generation Via Constructive ECR Process

The electrochemical activity of an ECR-derived catalyst depends on the physicochemical properties of real-time active sites on the surface after completion of the ECR. The inventors of the present inventive concept analyzed the ECR process of NbN and FeNbN electrodes to identify real-time active sites and the origin of the enhanced catalytic performance in the OER half-cell.

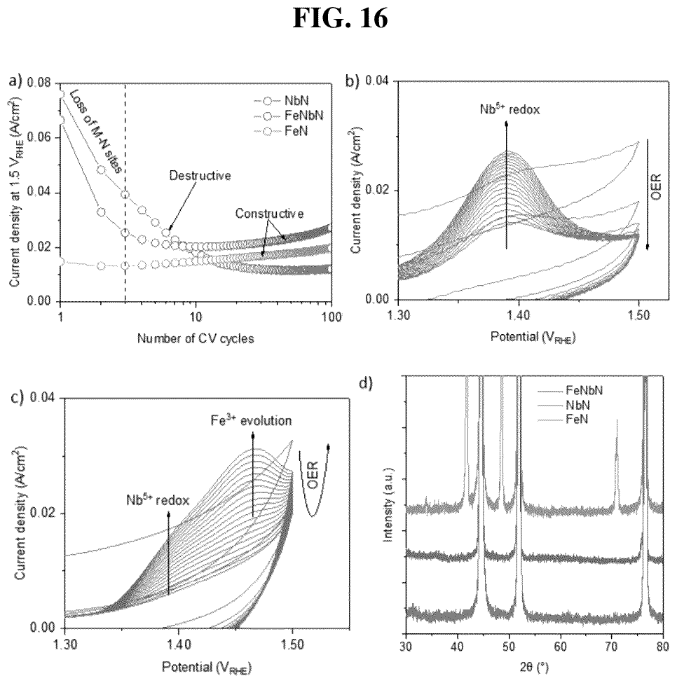

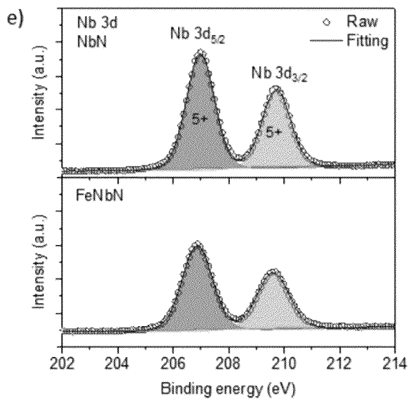

As shown in FIG. 13, the OER current density at 1.5 VRHE is plotted against the scanning number of CV cycles. As shown in FIG. 16a, the OER activities of NbN and FeNbN catalysts dramatically decrease during the first few CV cycles due to the loss of Nb—N and Fe—N active sites. According to the Pourbaix diagram, the Nb—N and Fe—N bonds are not stable in alkaline OER conditions. This is because N atoms leach into electrolyte solution as NH₃ and reacted immediately with H₂O to form NH₄OH, as follows:
Nb—N+3OH⁻→NbO₃⁻+NH₃
NH₃+H₂O→NH₄OH

At the electrode surface, NbO₃⁻ reacts with K⁺ ions in the electrolyte solution to form a stable KNbO₃ perovskite.
NbO₃⁻+K⁺→KNbO₃

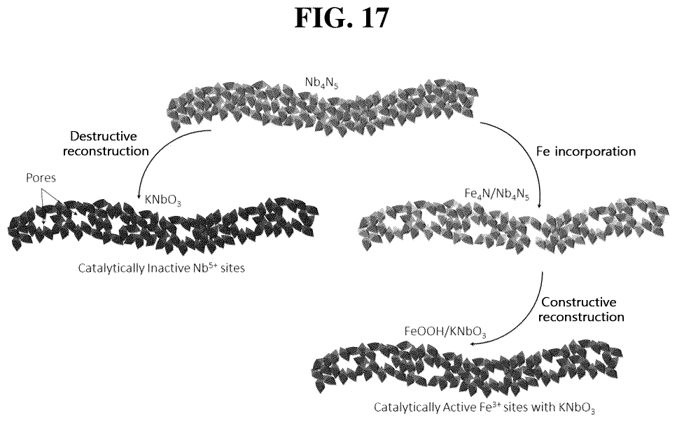

As shown in FIG. 17, KNbO₃ is generated in real-time from the NbN electrode after the ECR process. Furthermore, the OER activity of the NbN catalyst decreases and becomes constant after 30 CV cycles as shown in FIG. 16a, indicating no remaining Nb—N sites on the surface after completion of the ECR. As shown in FIG. 16b, further examination of the CV curve denotes that KNbO₃ is redox-active with an emerging oxidation peak at 1.38 V_{RHE}. The lowered OER current density indicates that the ECR-derived KNbO₃ species is catalytically inactive for OER. Therefore, the ECR process of NbN electrode under alkaline OER conditions is destructive. On the other hand, as for the case of FeNbN, the Fe—N bond is first converted to FeO₄²⁻/Fe(OH)₂ and then to FeOOH, as known as the catalytic reaction.
Fe(OH)₂+OH⁻→FeOOH+H₂O

As shown in FIG. 17, FeOOH and KNbO₃ are the real-time active sites formed through ECR for the FeNbN electrode. At the FeNbN electrode, although current density decreases during the first 10 CV cycles, the current density gradually increases afterwards. As shown in FIG. 16c, examination of the CV curves reveals that Fe³⁺ species are generated at 1.46 V_{RHE} and oxidation peak of Nb⁵⁺ is detected. The Fe3+ redox peak intensity increases with the number of CV cycles. This result indicates that the FeOOH phase slowly emerges as an active site for OER from the FeNbN electrode surface via the ECR process. Both FeOOH and KNbO₃ active sites exist on the FeNbN electrode surface after the ECR. As shown in FIG. 17, the increasing OER activity, along with the generation of Fe³⁺ species, clearly demonstrates that the incorporation of Fe ion into NbN surely redirects the destructive ECR path to be constructive. Moreover, the pristine FeN electrode also forms FeOOH active sites via a fully constructive ECR process, which exhibits a higher OER activity than the pristine Fe—N active sites, as shown in FIG. 13d. Still, the OER activity of FeOOH active sites derived from the FeNbN catalyst is higher than that of FeN-derived FeOOH. It shows that the formation of FeOOH active sites over the FeNbN electrode is more rapid and larger than the FeN electrode.

In FIG. 16d, XRD spectra of the catalysts after completion of the ECR process are evaluated. Both Nb₄N₅ and Fe₄N peaks disappeared, and none of the peaks assignable for FeOOH and KNbO₃ are detected, which indicates that those real-time active sites of NbN and FeNbN electrodes have amorphous phases. Only the FeN electrode shows surface reconstruction, judging from the emerged characteristic peaks of the Fe₄N phase. The reconstruction process is terminated when a newly generated FeOOH layer completely covers the underlying FeN by forming a core-shell architecture.

The FeOOH layer separates the FeN core from the electrolyte, which in turn prevents further degradation of FeN. The pristine FeNbN is a heterojunction catalyst, where the ECR-derived Nb₄N₅ and Fe₄N phases are simultaneously exposed to the electrolyte.

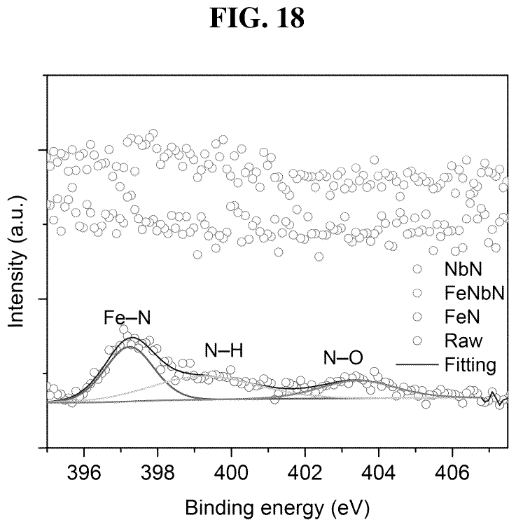

As shown in FIG. 16e, the high-resolution XPS spectra in the Nb 3d region show that both NbN and FeNbN catalysts mainly have the Nb⁵⁺ state corresponding to the KNbO₃ phase. As shown in FIG. 18, the N 1s peak completely disappears for NbN and FeNbN samples. The appearance of the Fe—N peak at 397.25 eV indicates that the FeOOH layer formed on the FeN electrode is very thin. As shown in FIG. 16f, the high-resolution XPS spectra of FeNbN catalyst in the Fe 2p region shows a characteristic Fe³⁺ peak at 713.15 eV, which confirms the formation of FeOOH active sites. The ratio of the Fe³⁺ (of FeOOH) and Fe²⁺ (Fe₄N, Fe(OH)₂) states before and after the ECR at the FeN and FeNbN electrode surfaces are compared in FIG. 16g. The FeNbN electrode has increased the Fe³⁺ content by 5.11 times through the ECR process, whereas the FeN electrode has increased the Fe³⁺ content of by only 1.75 times. The greater content of Fe³⁺ in the FeNbN catalyst is due to the facile formation of the catalytically active FeOOH species, promoted by the dissolution of Nb—N (formation of KNbO₃). On the other hand, in the case of FeN catalysts, the formation of FeOOH species is self-limited because the generated FeOOH layer covers the underlying FeN core.

The ECR behavior of the FeO electrode is also analyzed to compare with the

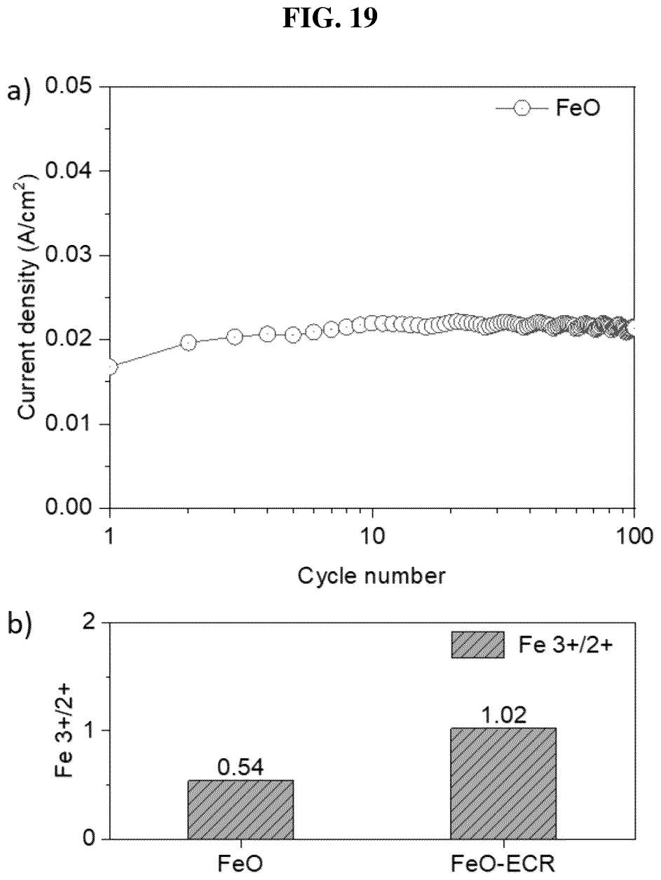

FeNbN electrode. As shown in FIG. 19, the ECR of FeO is also constructive, but the improvement in OER activity is not significant compared to the FeNbN electrode because the Fe³⁺ content ss increased only 2 times after the ECR. The formation of FeOOH through ECR is known due to operation of alkaline OER catalysis. Similar to Fe, both Co and Ni have constructive ECR behavior under alkaline OER conditions. The formation of FeOOH has been reported only to boost or modulate the intrinsically constructive ECR process with the first row Ni and Co transition metals. The present inventive concept is about incorporating FeOOH for the purpose of redirecting a destructive ECR process into a constructive way. This attempt highlights the possibility of designing industrial catalysts by modification of ECR and meliorating the detrimental impacts on pristine catalysts.

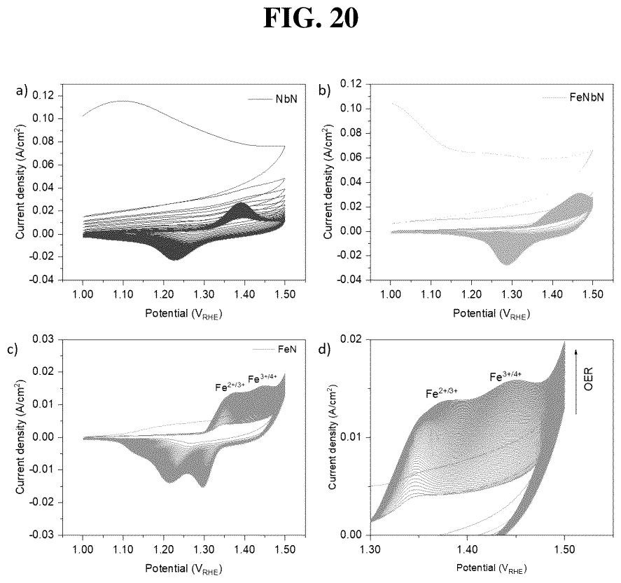

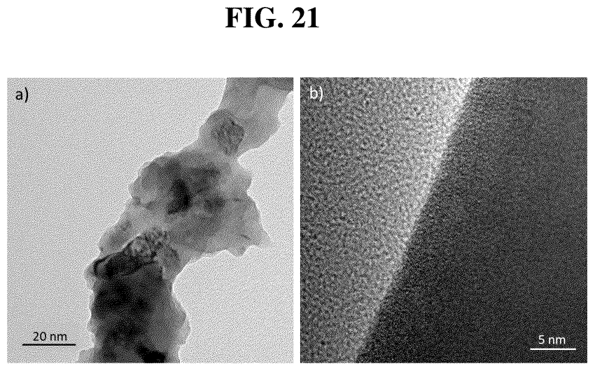

The HR-TEM images of the FeNbN catalyst after the ECR process are shown in FIG. 20a. The morphology of the FeNbN structure becomes porous and the FeNbN is composed of amorphous particles of KNbO₃ and FeOOH as shown in FIG. 17. As shown in FIG. 21, the NbN catalyst also exhibits a similar morphological change with high porosity.

As shown in FIG. 20b, the high magnification image shows a random arrangement of atoms without any visible lattice plane. The results are consistent with the XRD and ECSA analysis results in FIGS. 16d and 10f. Another significant impact of the ECR process is the varied porosity of the catalyst material. ECSA-normalized current density is obtained to demonstrate the impact of porosity.

As shown in FIG. 20c, the FeNbN electrode has faster OER kinetics than NbN or FeN electrodes. The results indicate that the main descriptor of electrochemical activity is the chemical composition at the electrode-electrode interface. The STEM-EDS mapping of the FeNbN electrode shows random distribution of Fe elements, while forming a separate FeOOH phase during the ECR process.

In the present inventive concept, a destructive ECR of OER catalyst material is induced as an electrochemical process and then a new synthetic strategy is performed to manipulate the ECR process to be constructive. That is, the destructive ECR of the Nb₄N₅ catalyst under alkaline conditions generates an inactive KNbO₃ species. The Nb₄N₅ material according to the present inventive concept is further modified through “active site optimization” by replacing Nb sites with thermodynamically stable Fe ions. The existing destructive ECR by Fe ions is successfully converted to a constructive ECR, and as a result, the OER kinetics of KNbO₃ is significantly increased.

### Experimental Example 5

### Seawater Electrolysis by Two-Electrode NbN∥FeNbN Cell

An NbN∥FeNbN two-electrode cell was assembled to analyze the overall water splitting performance. Industrially favorable high-temperature seawater splitting experiments were purposely conducted to evaluate the durability of the prepared catalyst under harsh operating conditions. Seawater sample was first filtered to remove debris and fine sand particles and was chemically treated with KOH to crystallize excess Ca and Mg ions in the forms of hydroxide and carbonate salts. The precipitated hydroxide/carbonate salts were removed by filtration. A two-electrode NbN∥FeNbN cell (separated with a Nafion membrane) was evaluated for overall water splitting performance using the seawater as an electrolyte. The NbN∥FeNbN full-cell was tested under industry-requiring operating conditions of high operating temperature (50-70° C.) and KOH concentration (20-30% by weight).

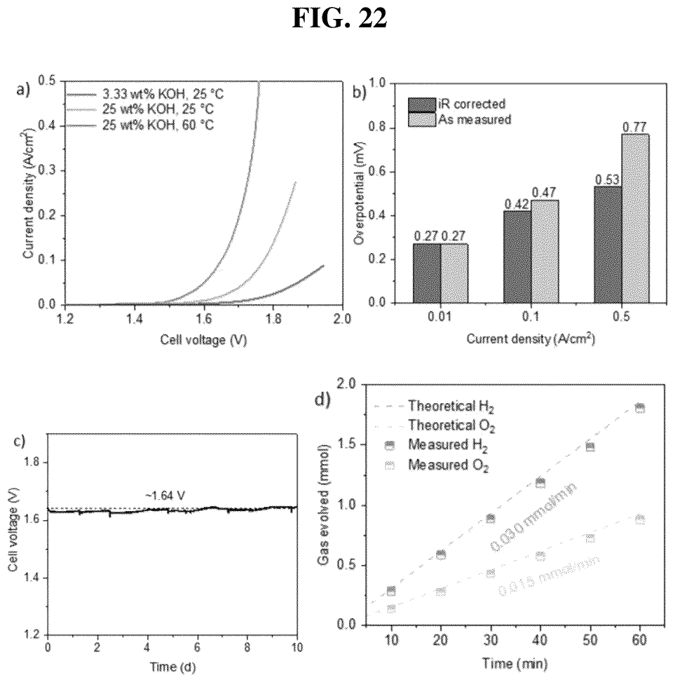

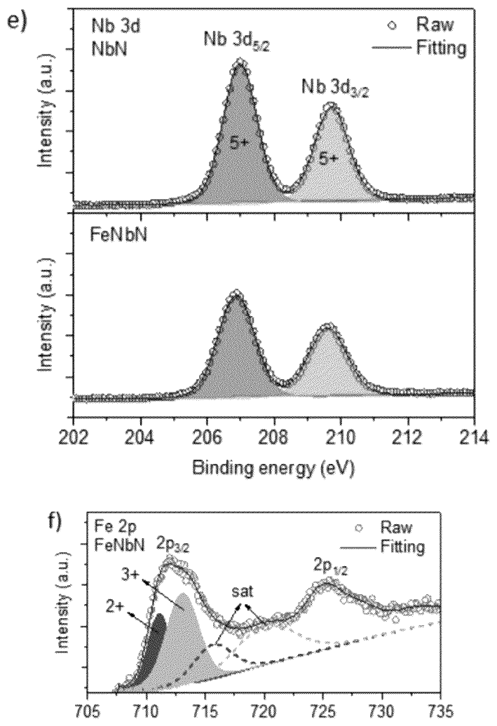

As shown in FIG. 22a, the reverse sweep-linear sweep voltammetry (RS-LSV) curves of the NbN∥FeNbN full-cell are obtained under different operating conditions. Overpotentials (with and without iR-correction) needed to obtain current densities of 10 mA/cm², 100 mA/cm², and 500 mA/cm² are compared in FIG. 22b, of which are less than the values of previous reports as shown in the following table 4.

TABLE 4

| | Cell assembly OER | | Current density | Overpotential | Stability |
|---|---|---|---|---|---|
| No. | electrode\|\|HER electrode | Electrolyte | (mA/cm²) | (mV) | (h) |
| 1 | NbN\|\|FeNbN | 25 w % KOH + seawater | 100 | 427 | 240 |
| | | at 60° C. | | | |
| 2 | NiCo₂S₄/NiS\|\|NiCo₂S₄/NiS | 6M KOH + seawater at | 100 | 337 | 240 |
| | | 80° C. | | | |
| 3 | NiFe/NiS\|\|NiO/Cr₂O₃ | 1M KOH + 1.5M NaCl | 400 | 790 | 1000 |
| | | 1M KOH + seawater | 400 | 890 | 1000 |
| | | 6M KOH + 1.5M NaCl at | 400 | 490 | 1000 |
| | | 80° C. | | | |
| 4 | NiMoN/NiFeN\|\|NiMoN | 1M KOH + seawater | 100 | 395 | — |
| | | | 500 | 751 | — |
| | | 6M KOH + seawater | 100 | 270 | 600 |
| 5 | NiFe LDH\|\|Pt | 0.1M KOH + 0.5M NaCl | 10 | 359 | 2 |
| 6 | Co₂[Fe(CN)₆)]\|\|NiMoS | phosphate buffer + | 10 | 870 | 20 |
| | | seawater (pH ~7) | | | |
| 7 | CoSe\|\|CoSe | natural seawater (pH ~7) | 10 | 570 | — |
| 8 | Ni₃N/Ni₃S₂\|\|Ni₃N/Ni₃S₂ | natural seawater (pH ~7) | 48.3 | 570 | — |
| 9 | S—(Ni/Fe)OOH\|\|NiCoN/NiₓP | natural seawater (pH ~7) | 10 | 580 | 24 |
| 10 | Fe₂O₃/NiO\|\|MoNi₄/MoO₂ | 1M KOH + seawater | 100 | 339 | 50 |
| 11 | NiFe—LDH\|\|NiMoN | 1M KOH + seawater | 500 | 435 | 100 |
| 12 | Ni₂P/Fe₂P\|\|Ni₂P/Fe₂P | 1M KOH + seawater | 100 | 581 | 48 |

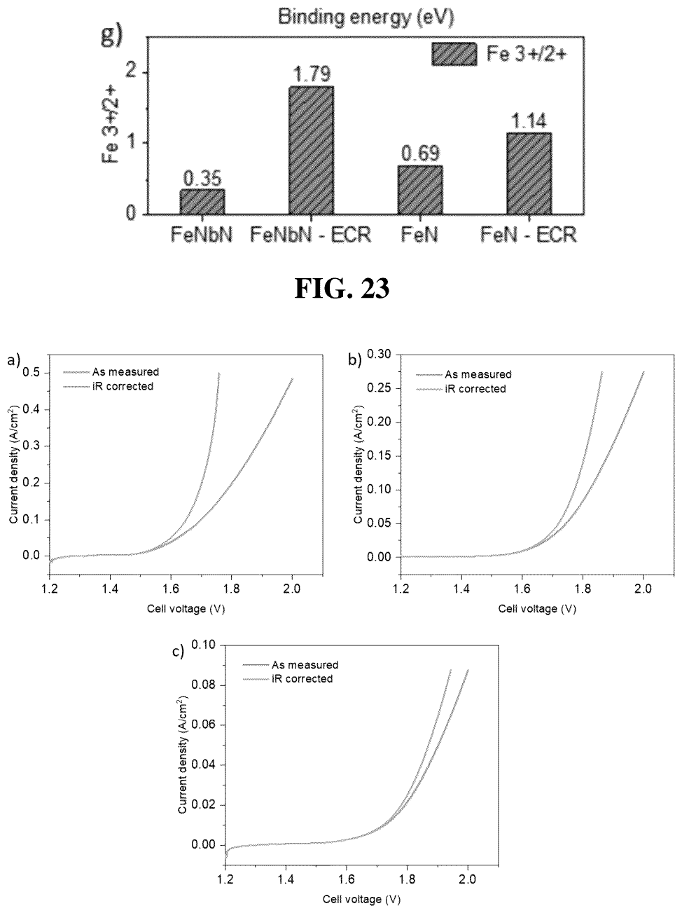

For comparison, the RS-LSV curves without iR-correction are shown in FIG. 23.

The durability of the NbN∥FeNbN full-cell is tested by continuous long-term electrolysis for 10 days under harsh operating conditions of 60° C., KOH 25 wt %, and 0.1 A/cm². A two-electrode NbN∥FeNbN cell (separated with a Sustainion X37-50 anion exchange membrane) is evaluated for a long-term electrolysis using the seawater as electrolyte. The full cell successfully maintained a cell voltage of about 1.64 V during the operation without any significant potential increase. The result presents that the NbN and FeNbN materials according to the present inventive concept are extremely durable and thus suitable to use as potential electrode candidates for industrial electrolysis.

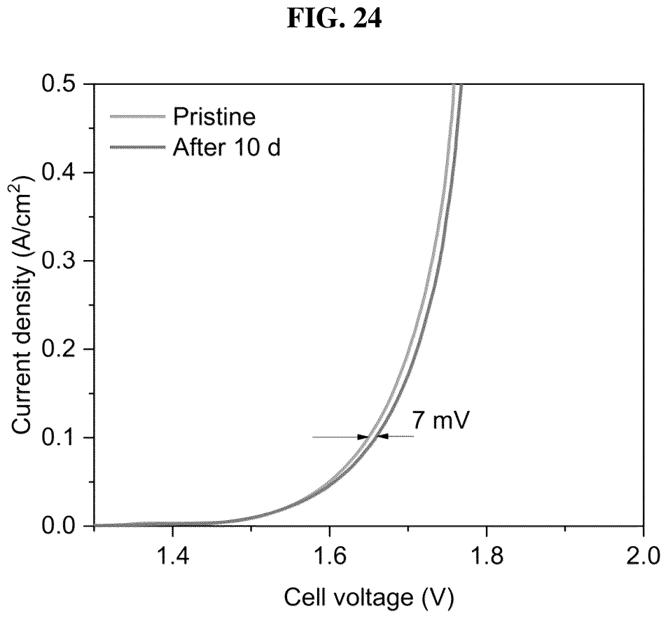

As shown in FIG. 22d, the evolution rate of H₂ and O₂ gas in the seawater electrolyte is measured to be 0.03 mmol/min and 0.015 mmol/min, respectively. As shown in FIG. 22g, the average Faradaic efficiency value is greater than ˜93%, which evidently demonstrates the high selectivity of NbN and FeNbN catalysts toward HER and OER, respectively. The electrode surface is examined by HR-SEM and XPS after 10 days of electrolysis to identify why NbN and FeNbN catalysts exhibits excellent durability. As marked as circles in FIGS. 22f and 22i, the morphology of NbN and FeNbN structures remains intact with no significant damage or aggregation, other than the adsorption of CaCO₃ particles on the electrode surface due to residual Ca ions in the seawater electrolyte. However, as shown in FIG. 24, the CaCO₃ adsorption barely affects the cell performance, as only additional 7 mV is required to reach 100 mA/cm² after 10 days of operation, according to the RS-LSV curve. As shown in FIGS. 22j to 22l and Table 5 below, XPS studies of the electrode samples after 10 days of operation show no traces of inorganic chlorides or magnesium derivatives other than the expected CaCO₃.

TABLE 5

| Electrochemical | | | | | | | |
|---|---|---|---|---|---|---|---|
| catalyst | Nb | N | O | Fe | Cl | Ca | Mg |
| NbN | 23.48 | 19.89 | 56.63 | — | — | — | — |
| FeNbN | 25.56 | 14.74 | 58.89 | 0.81 | — | — | — |
| NbN - after HER | 20.59 | 12.83 | 62.26 | — | 0.09 | 3.86 | 0.37 |
| FeNbN - after OER | 16.22 | 1.99 | 75.05 | 1.06 | 0.64 | 3.73 | 0.32 |

According to the present inventive concept, it is possible to demonstrate the seawater electrolysis using a 25 wt % KOH electrolyte and a catalyst subjected to an ECR process at 100 mA cm² for 10 days under industrially favorable conditions at 60° C. without a significant increase in cell voltage.

While the inventive concept has been shown and described with reference to certain preferred embodiments thereof, it will be understood by those skilled in the art that various changes in form and details may be made therein without departing from the spirit and scope of the inventive concept as defined by the appended claims.

10 Therefore, the scope of the inventive concept is defined not by the detailed description of the inventive concept but by the appended claims, and all differences within the scope will be construed as being included in the present inventive concept.

What is claimed is:

1. An Nb₄N₅ three-dimensional catalyst for a water electrolysis with a nitrogen-doped NbO nanostructure.

2. The Nb₄N₅ three-dimensional catalyst of claim 2, wherein the three-dimensional catalyst is composed of Nb₄N₅ crystals with a smooth surface and having a porous structure.

3. An Fe₄N/Nb₄N₅ three-dimensional catalyst for a water electrolysis with a nitrogen-doped FeNbO nanostructure.

4. The Fe₄N/Nb₄N₅ three-dimensional catalyst of claim 3, wherein the three-dimensional catalyst comprises Fe₄N nanoparticles randomly dispersed on the surface of Nb₄N₅.

5. The Fe₄N/Nb₄N₅ three-dimensional catalyst of claim 4, wherein the Fe₄N nanoparticles have a porous structure.

6. The Fe₄N/Nb₄N₅ three-dimensional catalyst of claim 3, wherein the catalyst has heterojunction between two phases of Nb₄N₅ and Fe₄N.

7. The Fe₄N/Nb₄N₅ three-dimensional catalyst of claim 3, wherein Fe—N bond of the catalyst is converted to active site of FeOOH under alkaline condition.

8. The Fe₄N/Nb₄N₅ three-dimensional catalyst of claim 7, wherein the activity site of FeOOH covers the underlying FeN.

9. A method for preparing three-dimensional catalyst, comprising
forming precursor solution by dissolving niobium chloride, oxalic acid and in solvent;
adding hexamethylenetetramine to the precursor solution, so that oxide containing Nb is formed by hydrothermal reaction; and
supplying ammonia gas to the oxide to perform nitrogen doping under thermal nitrification condition.

10. The method for preparing three-dimensional catalyst of claim 9, wherein the thermal nitrification condition has temperature range of 500° C. to 600° C.

11. The method for preparing three-dimensional catalyst of claim 9, wherein the precursor solution has iron nitrate further added therein.

12. The method for preparing three-dimensional catalyst of claim 11, wherein the oxide at which the ammonia gas is supplied is converted to Fe₄N/Nb₄N₅, and two phases of Nb₄N₅ and Fe₄N has heterojunction with each other.

13. The method for preparing three-dimensional catalyst of claim 9, wherein the hydrothermal reaction is formed on Ni foam.

14. A method for electrolysis of freshwater and seawater by means of a two-electrode cell composed of an Nb₄N₅ nanostructure electrode and an Fe₄N/Nb₄N₅ nanocomposite electrode.

15. The method for electrolysis of freshwater and seawater of claim 14, wherein the Fe₄N/Nb₄N₅ nanocomposite comprises Fe₄N nanoparticles randomly dispersed on the surface of Nb₄N₅.

16. The method for electrolysis of freshwater and seawater of claim 14, wherein the electrolysis of freshwater and seawater can be demonstrated with a 25 wt % KOH electrolyte at a current density of 100 mA cm² for 10 days without an increase in cell voltage.
